(19) United States
(12) Patent Application Publication
(10) Pub. No.: US 2023/0311779 A1
(43) Pub. Date: Oct. 5, 2023

(54) TRAILER HITCH STORAGE

(71) Applicants: Scott Bergren, New Canaan, CT (US); Gregory Tsouprake, Plano, TX (US)

(72) Inventors: Scott Bergren, New Canaan, CT (US); Gregory Tsouprake, Plano, TX (US)

(21) Appl. No.: 17/709,261

(22) Filed: Mar. 30, 2022

(51) Int. Cl. B60R 9/00

(52) U.S. Cl. CPC B60R 9/00

(57) ABSTRACT

A trailer hitch includes a receiver for mounting and securing a first hitch ball mount for towing, and one or more receptacles configured to prevent use for towing and for storing a second hitch ball mount. A receptacle for storing a hitch ball mount includes an enclosure secured to a vehicle and positioned to secure a hitch ball mount such that a rise or drop of the hitch ball mount is perpendicular to a lateral dimension of the vehicle. A mounting plate for storing a hitch ball mount including a mounting pin for insertion through a hitch pin hole of the hitch ball mount, and a clip fastened to the mounting plate and configured to capture sides of the hitch ball mount to secure the hitch ball mount to the mounting plate, and a mounting pin clip fastened to the mounting plate and configured to extend around the hitch ball mount and fasten to the mounting pin to further secure the hitch ball mount to the mounting plate.

### FIELD

The disclosed exemplary embodiments are directed to trailering, and in particular, to a various implementations of hitch ball mount storage.

### BACKGROUND

Trailer hitch assemblies are generally used to fasten various trailered loads to vehicles for towing. As shown in FIG. 1, a trailer hitch assembly 100 may include a trailer hitch 102, a cuboid receiver tube 104, a hitch ball mount 106, a hitch pin 108 inserted through a hole in the receiver tube 104 and a corresponding hole 110 in the hitch ball mount 106, a trailer ball 112, a trailer coupler 114 coupled to a trailer 116. The hitch pin 108 is inserted through the hole in the receiver tube 104 and the corresponding hole 110 in the hitch ball mount 106 to secure the hitch ball mount 106 in the receiver tube 104 during towing. The trailer hitch assembly 100 generally includes a wiring harness 118 and safety chains 120.

The trailer hitch 102 is attached to a vehicle, generally to the chassis, such that the cuboid receiver tube 104 extends toward the rear of the vehicle. The hitch ball mount 106 is inserted into the receiver tube 104 and fixed by inserting the hitch pin 108 through the receiver tube 104 and the hole 110 in the hitch ball mount 106. The trailer ball 112 is attached to a platform 122 of the hitch ball mount 106 at a specified height C (FIG. 2), generally determined by the height of the trailer coupler 114 used to fasten the trailer 116 to the trailer ball 108. The hitch ball height C (FIG. 2) and the size of the trailer ball 112 may also depend on the item being towed (boat, flatbed trailer, cargo trailer, camper, etc. . . . ), and the amount of required rise or drop (FIG. 2).

FIG. 3 shows a schematic diagram of a typical trailer hitch.

In some cases the trailer 116 may require a hitch assembly with a higher height in order to trailer correctly and the trailer ball 112 may be mounted on a rising hitch ball mount 402 (FIG. 4). In other cases the trailer may require a lower hitch in order to trailer correctly and the trailer ball 112 may be mounted on a drop hitch ball mount 502 (FIG. 5). The rising and dropping hitch ball mounts can vary in the amount of vertical change, for example. FIGS. 4 and 5 illustrate a relatively small rise 402 and a relatively small drop 502, respectively, while FIG. 6 illustrates a relatively large drop 602.

Additionally some trailers may require a different size trailer ball, which may range in diameter from 1¾″ to 2½″ in ⅛″ increments. While it is possible to change the trailer ball 112 on any given hitch ball mount, it is very impractical and time consuming. As shown in FIG. 7, for safety reasons, the trailer ball 112 is attached using a very strong lock washer 702 and pin 704 fastened through the hitch ball bolt 706 to prevent loosening of the ball mount nut 708.

Furthermore, the hitch receptacle size may also vary. Typical sizes may include, for example, 1¼″, 2″, 2½″, and 3″.

There are products available that attempt to overcome these disadvantages by using an adjustable height hitch ball mount with a selection of different diameter trailer balls, an example of which is shown in FIG. 8 as item 802. This type of assembly allows a user to vary the rise or drop and in some cases rotate the hitch ball mount to select among a number of trailer balls. However, the assembly is complicated, expensive, and requires maintenance, more so than a collection of hitch ball mounts. Furthermore, the excessive cost makes the item a theft target, necessitating additional cost to secure or lock it to the vehicle. Given that several components are removable, multiple security devices or locks may be required.

Still further, the adjustable hitch ball mount 802 generally extends the trailer ball 110 further behind the vehicle. A standard hitch ball mount may extend approximately 9″ behind the vehicle, while the adjustable hitch ball mount 802 may extend approximately 12″ or more. For vehicles equipped with distance measurement devices, for example, backup sensors, ultrasonic distance measurement equipment, and backup cameras, the backup sensors and distance measuring equipment are calibrated from the vehicle rear bumper and therefore assume that the vehicle end is actually at the back bumper. Thus, a user may be misled as to the distance between the vehicle and another obstacle, for example, a person, structure, or another vehicle. While the vehicle sensors may indicate additional distance to an obstacle, the adjustable hitch ball mount may contact the obstacle with the potential for damaging a vehicle or structure or injuring a person.

There are existing hitch ball mount holder storage devices for mounting outside a sidewall of, or within a pickup truck cargo bed, an example of which is shown as item 902 in FIGS. 9A and 9B. The device 902 requires hitch ball mounts to be inserted vertically, limiting installation options. For example, many ½ ton pickups have short wheel bases that utilize folding cargo bed extenders that operate to increase cargo capacity by unfolding over a lowered tailgate. The device 902 may interfere with the folding and storage of the bed extenders. The vertical orientation makes the device 902 cumbersome to install in an SUV or van side panel or under a seat. Furthermore, the device configuration requires that the rise or drop and the ball extend into the cargo area as the ball mount can not be inserted sideways. As a result, a ball mount with any significant rise or drop, for example 2″ or more, obstructs the cargo area which limits the size and configuration of any cargo. For example, the device 902 prohibits carrying large cargo such as a full sheet of plywood or a 4 wheel ATV. Still further, the device 902 is constructed of metal which allows metal to metal vibration and noise which is noticeable in the passenger compartment when mounted in the cargo bed, and is completely unacceptable when the device is located in the passenger compartment, such as under a seat or in a side panel.

Another method for overcoming these disadvantages is to maintain multiple hitch ball mounts with different heights and ball sizes, as needed. Given that there are no specific hitch ball mount storage locations provided as standard equipment on current production vehicles, hitch ball mounts may be stored haphazardly, for example, loose in a vehicle cargo area where the hitch ball mount can move and cause damage to other cargo and the vehicle itself, loose in the vehicle cabin with the possibility of causing mayhem (imagine being hit in the ankle by a 15 lb. hitch ball mount as it slides during hard braking), or in the user's garage or home, where the hitch ball mount is safe from causing damage, but unavailable when needed. Any storage outside the vehicle may occupy needed space and presents the possibility of being away from the vehicle when actually needed.

### SUMMARY

It would be advantageous to provide a storage solution for hitch ball mounts that accommodates multiple hitch ball mounts, is on the vehicle on which the hitch ball mounts are utilized, safely secures the hitch ball mounts, and is in a generally otherwise unused location.

The disclosed embodiments are directed to a trailer hitch including a receiver for mounting and securing a first hitch ball mount for towing, and one or more receptacles configured to prevent use for towing and for storing a second hitch ball mount.

The receiver may be configured to secure the first ball hitch mount using a hitch pin.

The one or more receptacles may be positioned to prevent the second hitch ball mount from being inserted with a trailer ball facing upward.

The one or more receptacles may be positioned such that a trailer ball of the second hitch ball mount is inaccessible.

The one or more receptacles may include a hitch ball mount retaining mechanism that releases when subjected to less than a towing force.

In another aspect, the disclosed embodiments are directed to a receptacle for storing a hitch ball mount including an enclosure secured to a vehicle and positioned to secure a hitch ball mount such that a rise or drop of the hitch ball mount is perpendicular to a lateral dimension of the vehicle.

The receptacle may include a receptacle hole corresponding to a hitch pin hole of the hitch ball mount and a hitch pin configured to be inserted through the receptacle hole and hitch pin hole to secure the hitch ball mount in the receptacle.

The receptacle may also include a spring box mounted to the receptacle, the spring box enclosing a spring and a spring retainer biased by the spring to extend into a hitch pin hole of the hitch ball mount to secure the hitch ball mount in the receptacle.

The receptacle may further include a spring clip mounted to the receptacle, the spring clip including a pin and a pin retainer biased by the spring clip to extend into a hitch pin hole of the hitch ball mount to secure the hitch ball mount in the receptacle.

The enclosure may be secured to one or more structural components within a side wall of the vehicle.

The enclosure may be secured under a lid of the side wall of the vehicle.

The enclosure may be secured to a side wall of a passenger compartment of the vehicle.

The enclosure may be secured to a side wall of a cargo area of the vehicle.

In a further aspect of the disclosed embodiments, a mounting plate for storing a hitch ball mount includes a mounting pin for insertion through a hitch pin hole of the hitch ball mount, a clip fastened to the mounting plate and configured to capture sides of the hitch ball mount to secure the hitch ball mount to the mounting plate, and a mounting pin clip fastened to the mounting plate and configured to extend around the hitch ball mount and fasten to the mounting pin to further secure the hitch ball mount to the mounting plate.

The mounting plate may include a cotter pin hole extending through the mounting pin configured for accepting a cotter to further secure the hitch ball mount to the mounting plate.

### BRIEF DESCRIPTION OF THE DRAWINGS

FIGS. 1 and 2 show components of a trailer hitch and a trailer coupled together;

FIG. 3 shows a schematic diagram of a typical trailer hitch;

FIGS. 4 and 5 illustrate hitch ball mounts with a relatively small rise and a relatively small drop, respectively;

FIG. 6 illustrates a hitch ball mount with a relatively large drop;

FIG. 7 shows a fastening mechanism for attaching a trailer ball to a hitch ball mount;

FIG. 8 depicts an adjustable height hitch ball mount with a selection of different diameter trailer balls;

FIGS. 9A and 9B show an existing hitch ball mount holder for mounting on a sidewall of a pickup truck cargo bed;

FIG. 10 illustrates one disclosed embodiment that includes a trailer hitch with multiple receivers;

FIGS. 11A-11C illustrate an embodiment that includes one or more hitch ball mount storage receptacles built into a tailgate or sidewall of a vehicle;

FIG. 12 depicts a cross sectional view of another receptacle with an alternate method of securing the hitch ball mount;

FIG. 13A illustrates a cross sectional front view and FIG. 13B illustrates a rear view of another receptacle with yet another method of securing the hitch ball mount;

FIG. 14A depicts a mounting plate providing a still further method of securing the hitch ball mount; and

FIG. 14B depicts a hitch ball mount attached to the mounting plate.

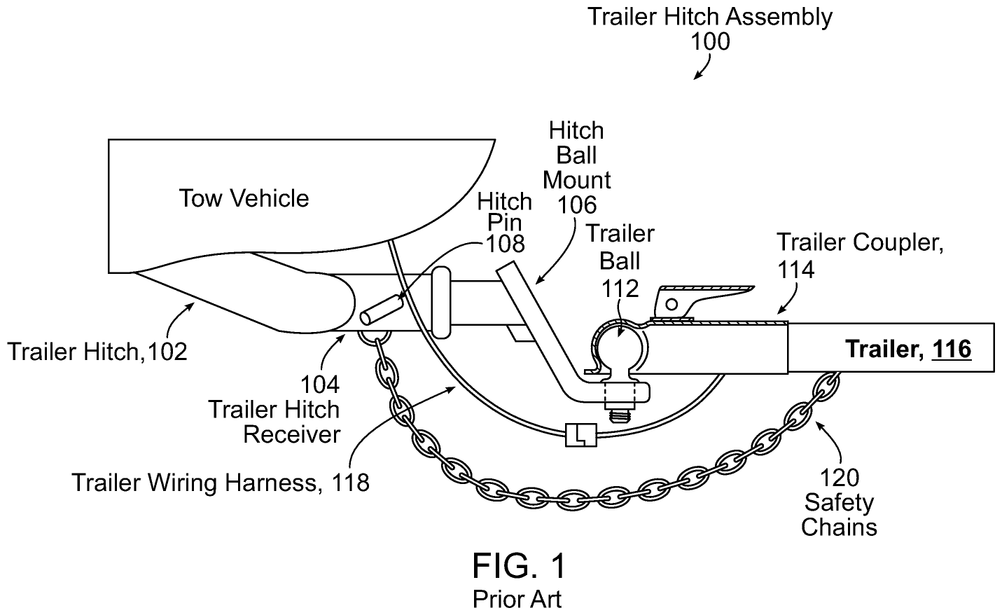

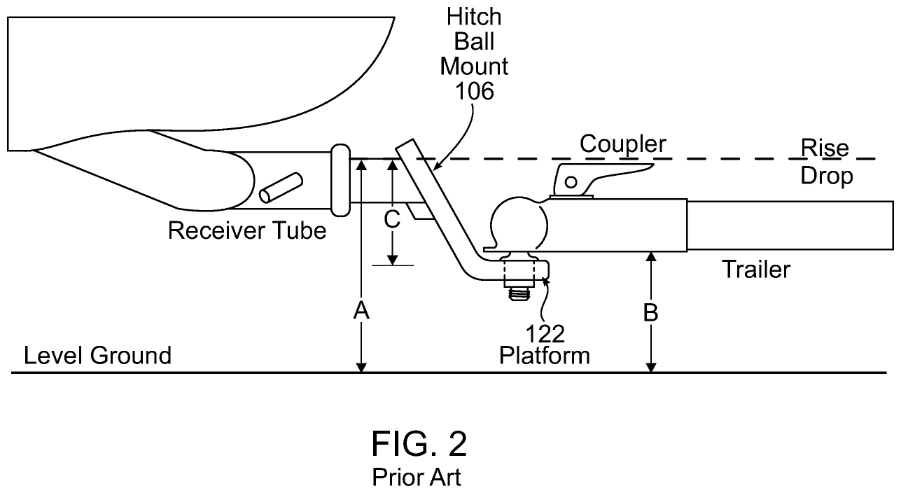

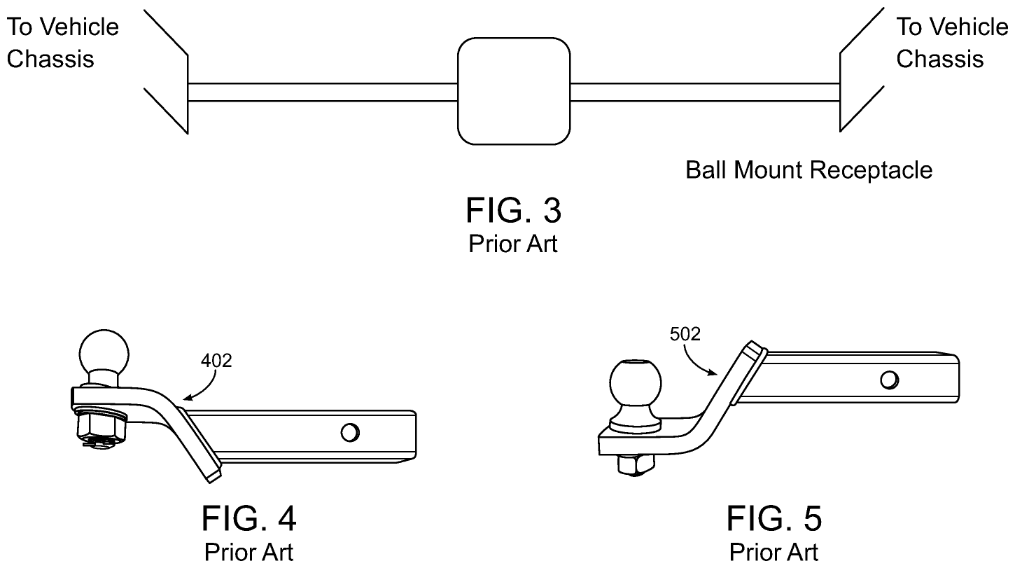

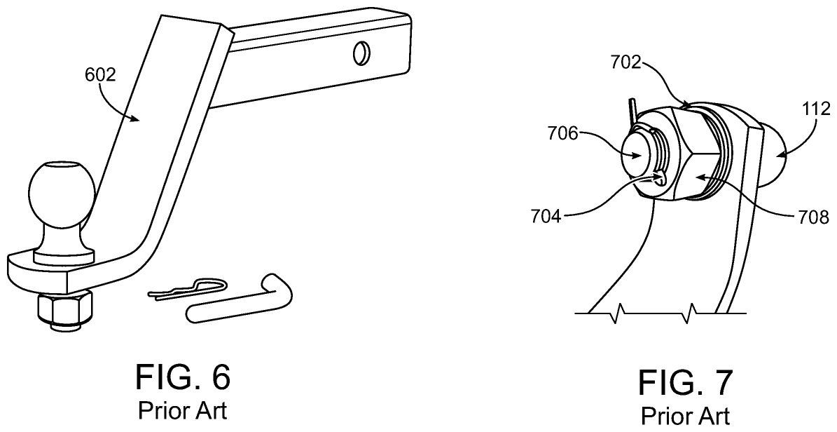

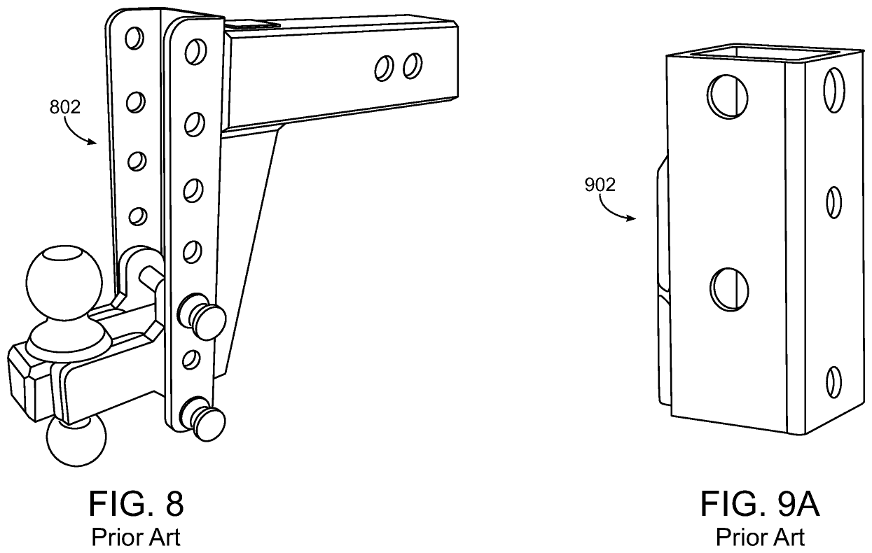

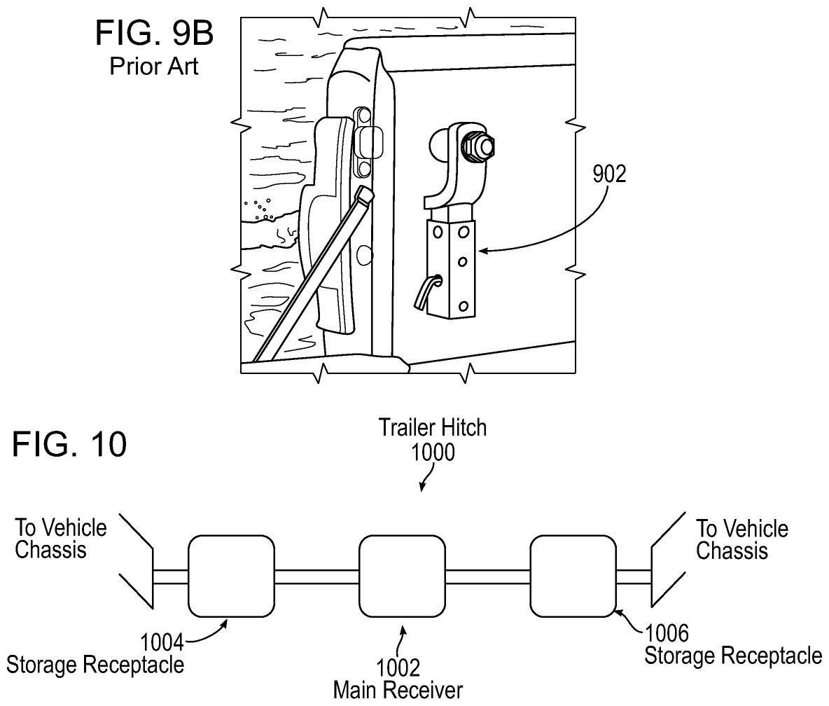

### DETAILED DESCRIPTION

The disclosed embodiments are directed to a solution that provides convenient on vehicle storage for multiple hitch ball mounts that safely secure each ball hitch mount in a generally otherwise unused location.

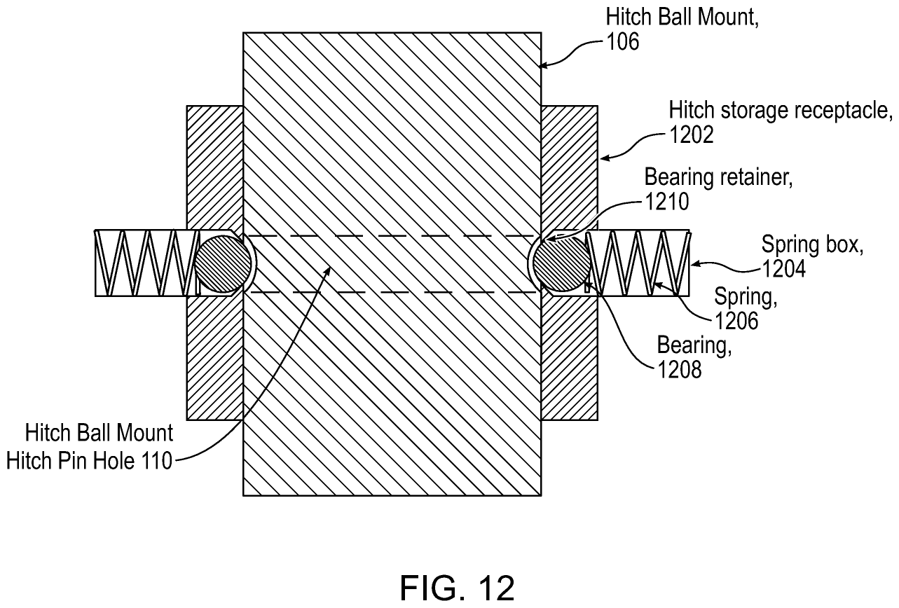

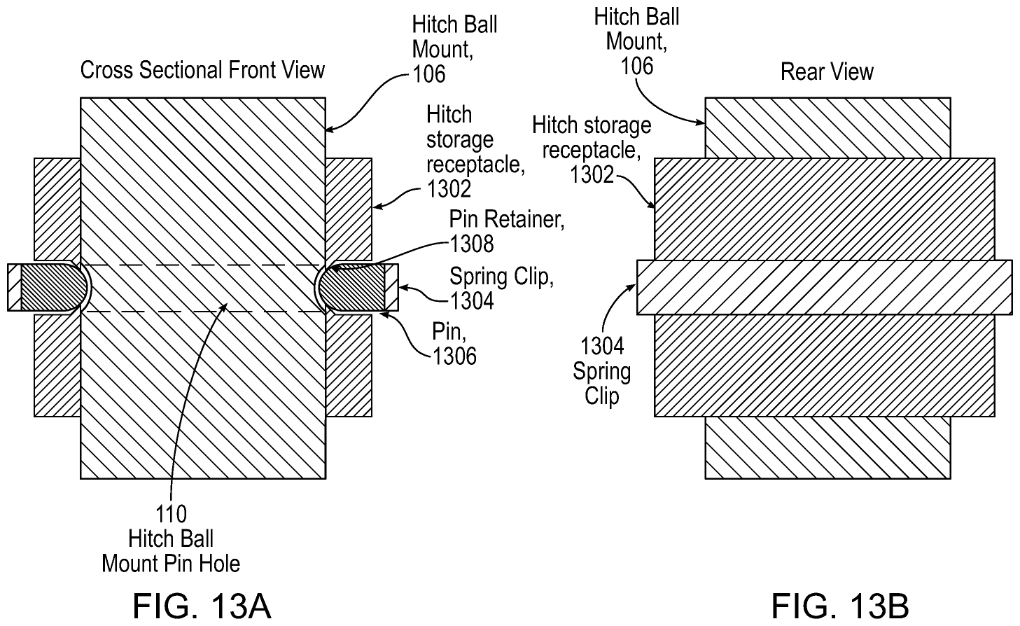

FIG. 10 illustrates an embodiment that includes a trailer hitch 1000 with multiple receivers. For example, the trailer hitch 1000 may include a main trailer hitch receiver 1002 and additional receptacles 1004, 1006 into which hitch ball mounts 106 may be inserted for storage. The additional receptacles 1004, 1006 may be arranged to prevent use during towing. For example, the additional receptacles may be positioned such that the hitch ball mounts 106 may be prevented from being inserted with the trailer ball facing upward. In some embodiments, the additional receptacles may be positioned such that the trailer ball is inaccessible. In other embodiments, the hitch ball mounts 106 may be secured with a releasable mechanism, for example, the spring based mechanisms described below and shown in FIGS. 12, 13A and 13B below, such that a towing force acts to disconnect the hitch ball mounts 106 from the additional receptacles 1004, 1006.

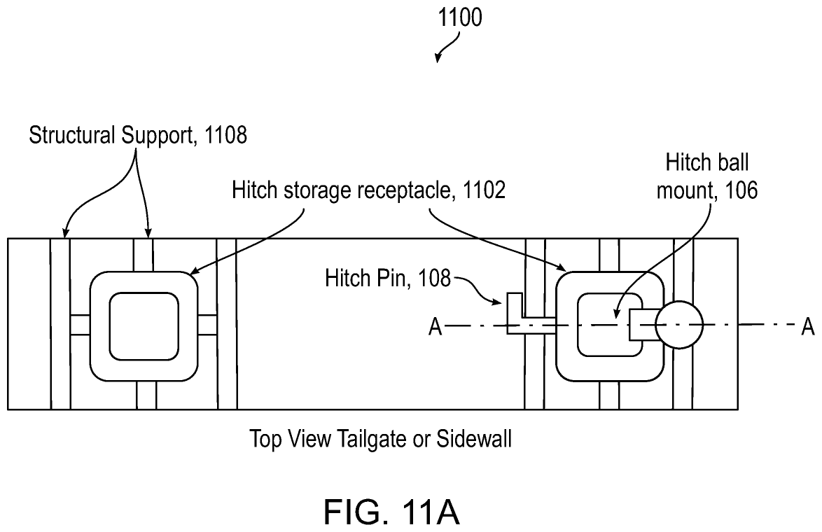

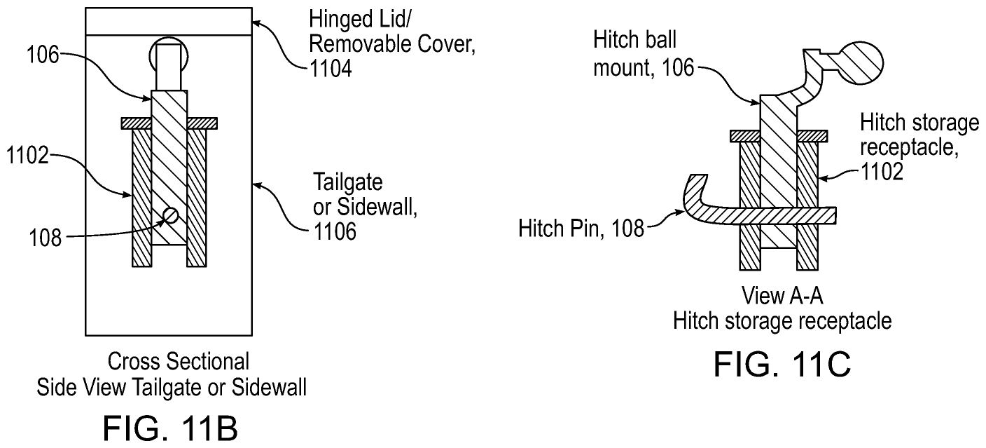

FIGS. 11A-11C illustrate an embodiment 1100 that includes one or more hitch ball mount storage receptacles built into a tailgate or sidewall of a vehicle. In this embodiment, storage receptacles 1102 are located under a hinged lid or removable cover 1104 and mounted vertically inside a vehicle tailgate or sidewall 1106. The receptacle 1102 may be attached to one or more structural supports 1108 in the interior of the tailgate or sidewall 1106. The hitch ball mounts 106 may be secured in the receptacles 1102 by various means including by their own weight, by contact and pressure provided by the hinged lid or removable cover 1104, or using the same hitch pin 108 used to secure the hitch ball mounts 106 into the trailer hitch receiver 104.

However, using just the ball mount weight to secure the hitch ball mounts may allow unwanted movement and may potentially cause damage to the vehicle, and securing the hitch ball mount using the hitch pin may require manually inserting the pin through a very narrow and crowded space.

FIG. 12 depicts a cross sectional view of another receptacle 1202 with an alternate method of securing the hitch ball mount 106. The receptacle 1202 includes a spring box 1204 on one or more sides of the receptacle 1202 with a spring 1206 biasing a bearing 1208 against a bearing retainer 1210 that is positioned to protrude into the hitch pin hole 110 in the hitch ball mount 106. In this embodiment, the bearing 1208 snaps into place when the hitch ball mount 106 is inserted into the receptacle 1202. The bearing releases when the hitch ball mount 106 is pulled upward with enough force to remove the hitch ball mount 106. This embodiment eliminates the need for manually inserting and removing the hitch pin 108.

FIG. 13A illustrates a cross sectional front view and FIG. 13B illustrates a rear view of another receptacle 1302 with yet another method of securing the hitch ball mount 106. In this embodiment, a spring clip 1304 spans the receptacle 1302 and operates to bias pins 1306 against pin retainers 1308 protruding into hitch ball mount pin holes 110 in the hitch ball mount 106.

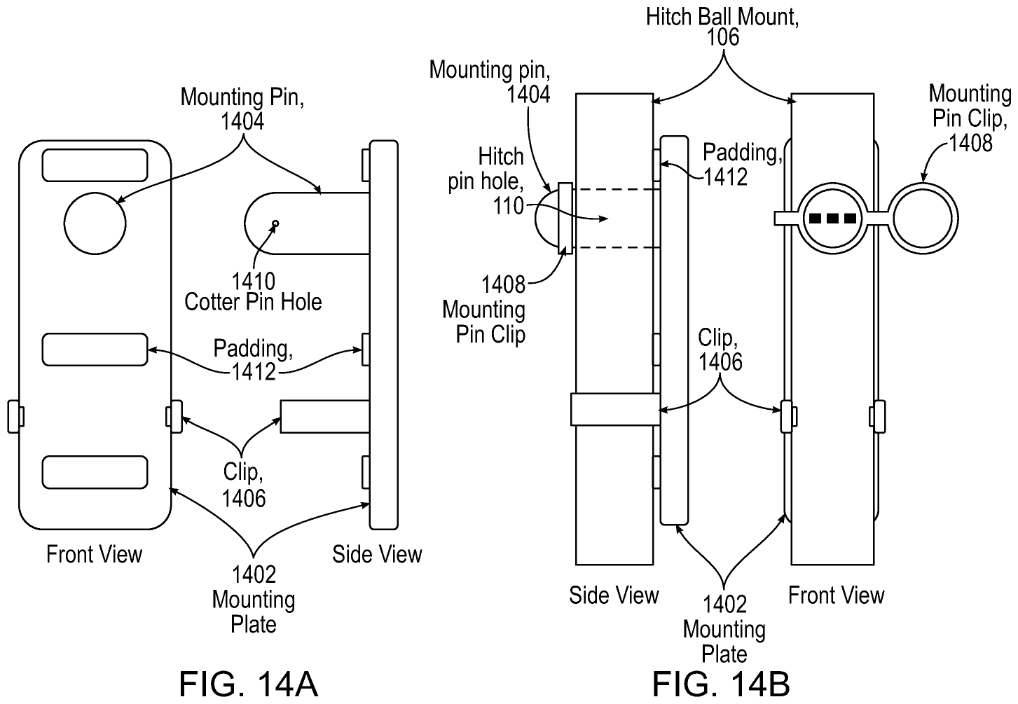

FIG. 14A depicts a mounting plate 1402 providing a still further method of securing the hitch ball mount 106, and FIG. 14B depicts a hitch ball mount 106 attached to the mounting plate 1402. The mounting plate 1402 may be mounted to the vehicle in any suitable location. The mounting plate 1402 may include a mounting pin 1404 and a clip 1406. The hitch ball mount 106 is mounted on the mounting plate 1402 by sliding the hitch pin hole 110 of the hitch ball mount over the mounting pin 1404 until the mounting pin 1404 protrudes through the pin hitch pin hole 110 and the hitch ball mount 106 is captured by the clip 1406 and rests against the mounting plate 1402. The clip 1406 may include any of a spring clip, clamp, buckle, magnet, Velcro strap, or any other suitable fastening device. A mounting pin clip 1408 may be fastened to the mounting plate 1402 and to the mounting pin 1404 to further secure the hitch ball mount 106. A cotter pin may be inserted into a cotter pin hole 1410 in the mounting pin 1404 to still further secure the hitch ball mount 106. Padding 1412 may be provided on the mounting plate 1402 to eliminate surface to surface rattling and noise.

While the storage receptacles 1102, 1202, 1302, 1402 are described as located under a hinged lid or removable cover, or mounted vertically inside a vehicle tailgate or sidewall, it should be understood that the storage receptacles may be located inside a vehicle cabin, such as under a seat, or in an inside wall behind an access panel. Other receptacle locations may include attaching the receptacles to an inside wall of a cargo bed, an inside wall of an interior cargo area, or to the vehicle undercarriage. If located above or to either side of a wheel well in the cargo bed, storage of the hitch ball mount would be out of the way, still allowing large items such as full size sheets of plywood, drywall, four wheel ATVs, etc. . . . to be loaded into the cargo bed.

While the storage receptacles 1102, 1202, 1302, 1402 are described as being mounted vertically, it should be understood that the storage receptacles may be mounted horizontally allowing the hitch ball mount 106 to be inserted and removed horizontally rather than vertically. The hitch ball mount 106 may be mounted horizontally such that any amount of rise or drop may be accommodated flush against a cargo bed wall or cabin wall and avoid interference with cargo and cabin loads.

It should also be understood that the disclose embodiments may be constructed of any suitable material including any compatible metal, metal alloy, plastic, padding, shock absorbing material or any combination of material suitable for the embodiments disclosed herein.

All of the embodiments can be used for any size ball mount/receptacle size (1″, 2″ etc. . . . ) by simply sizing the device accordingly. For example a vehicle with a 2″ receptacle would require storage for 2″ ball mounts, while a vehicle with a 1″ receptacle requires storage for 1″ ball mounts. Further, all of the embodiments can be utilized to store ball mount adaptor sleeves. For example a sleeve that allows a 1″ ball mount to be used with a 2″ receptacle.

The various embodiments described above are provided by way of illustration only and should not be construed to limit the scope of the disclosure. For example, the principles herein apply generally to any large, standardized data set. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

What is claimed is:

1. A trailer hitch comprising:
a receiver for mounting and securing a first hitch ball mount for towing; and
one or more receptacles configured to prevent use for towing and for storing a second hitch ball mount.

2. The trailer hitch of claim 1, wherein the receiver is configured to secure the first ball hitch mount using a hitch pin.

3. The trailer hitch of claim 1, wherein the one or more receptacles are positioned to prevent the second hitch ball mount from being inserted with a trailer ball facing upward.

4. The trailer hitch of claim 1, wherein the one or more receptacles are positioned such that a trailer ball of the second hitch ball mount is inaccessible.

5. The trailer hitch of claim 1, wherein the one or more receptacles comprise a hitch ball mount retaining mechanism that releases when subjected to less than a towing force.

6. A receptacle for storing a hitch ball mount comprising:
an enclosure secured to a vehicle and positioned to secure a hitch ball mount such that a rise or drop of the hitch ball mount is perpendicular to a lateral dimension of the vehicle.

7. The receptacle of claim 6, comprising:
a receptacle hole corresponding to a hitch pin hole of the hitch ball mount; and
a hitch pin configured to be inserted through the receptacle hole and hitch pin hole to secure the hitch ball mount in the receptacle.

8. The receptacle of claim 6, comprising:
a spring box mounted to the receptacle, the spring box enclosing:
a spring and a spring retainer biased by the spring to extend into a hitch pin hole of the hitch ball mount to secure the hitch ball mount in the receptacle.

9. The receptacle of claim 6, comprising:
a spring clip mounted to the receptacle, the spring clip including:
a pin and a pin retainer biased by the spring clip to extend into a hitch pin hole of the hitch ball mount to secure the hitch ball mount in the receptacle.

10. The receptacle of claim 6, wherein the enclosure is secured to one or more structural components within a side wall of the vehicle.

11. The receptacle of claim 7, wherein the enclosure is secured under a lid of the side wall of the vehicle.

12. The receptacle of claim 6, wherein the enclosure is secured to a side wall of a passenger compartment of the vehicle.

13. The receptacle of claim 6, wherein the enclosure is secured to a side wall of a cargo area of the vehicle.

14. A mounting plate for storing a hitch ball mount comprising:
a mounting pin for insertion through a hitch pin hole of the hitch ball mount;
a clip fastened to the mounting plate and configured to capture sides of the hitch ball mount to secure the hitch ball mount to the mounting plate; and
a mounting pin clip fastened to the mounting plate and configured to extend around the hitch ball mount and fasten to the mounting pin to further secure the hitch ball mount to the mounting plate.

15. The mounting plate of claim 14, further comprising a cotter pin hole extending through the mounting pin configured for accepting a cotter to further secure the hitch ball mount to the mounting plate.
